(19) United States
(12) Patent Application Publication
(10) Pub. No.: US 2017/0071037 A1
(43) Pub. Date: Mar. 9, 2017

(54) LIGHT-EMITTING DIODE DEVICE

(71) Applicant: Lextar Electronics Corporation, Hsinchu (TW)

(72) Inventors: En-Min Wu, Taipei City (TW); Hsien-Chih Ho, Zhubei City (TW)

(21) Appl. No.: 15/008,490

(22) Filed: Jan. 28, 2016

(30) Foreign Application Priority Data
Sep. 7, 2015 (TW) 104129505

(51) Int. Cl. H05B 33/08; F21V 23/00

(52) U.S. Cl. CPC H05B 33/0815; H05B 33/0887; H05B 33/0845; F21V 23/005; F21Y 2115/10

(57) ABSTRACT

A light-emitting diode (LED) device including an LED module and a driver is provided. The LED module includes a voltage sensing module and an LED. The voltage sensing module generates a reference voltage. The driver includes a power converting module, a current processing module, a feedback module and a controller module. The power converting module converts an alternating current (AC) into a driving current for driving the LED to emit a light. The current processing module converts the driving current into a sensing voltage. The feedback module compares the sensing voltage with a reference voltage and outputs a level signal according to a magnitude relationship of the sensing voltage and the reference voltage. The controller module outputs a pulse width modulation (PWM) signal to the power converting module according to the level signal. The power converting module controls the magnitude of the driving current according to the PWM signal.

This application claims the benefit of Taiwan application Serial No. 104129505, filed Sep. 7, 2015, the disclosure of which is incorporated by reference herein in its entirety.

### TECHNICAL FIELD

The disclosure relates in general to a light-emitting diode (LED) device, and more particularly to an LED device capable of controlling a magnitude of a driving current.

### BACKGROUND

A conventional light-emitting diode (LED) module is driven by a driving circuit. Based on the magnitude of the driving current required for driving an LED module, a corresponding driving circuit is selected to work with the LED module. When many LED modules requiring different driving currents are used, different driving circuits for providing the required driving currents need to be designed, not only increasing design and manufacturing costs but also adding extra workload to warehousing management, material assignment and component assembly.

Therefore, it has become a prominent task for the industry to provide a new LED device for resolving the above problems.

### SUMMARY

The disclosure is directed to a light-emitting diode (LED) device capable of reducing both the design cost and the manufacturing cast.

According to one embodiment, a light-emitting diode (LED) device including an LED module and a driver is provided. The LED module includes a voltage sensing module and an LED. The voltage sensing module is configured to generate a reference voltage. The driver includes a power converting module, a current processing module, a feedback module and a controller module. The power converting module is configured to receive and convert an alternating current (AC) into a driving current for driving the LED to emit a light. The current processing module is configured to convert the driving current into a sensing voltage. The feedback module is configured to compare the sensing voltage with a reference voltage and output a level signal according to a magnitude relationship of the sensing voltage and the reference voltage. The controller module is configured to output a pulse width modulation (PWM) signal to the power converting module according to the level signal. The power converting module is further configured to control the magnitude of the driving current according to the PWM signal.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a cross-sectional view of an LED device according to an embodiment of the invention.

FIG. 2 is functional diagram of the LED device of FIG. 1.

FIG. 3 is a curve diagram of driving current according to an embodiment of the invention.

FIG. 4 is a diagram of PWM signal according to an embodiment of the invention.

FIG. 5 is a diagram of PWM signal according to another embodiment of the invention.

FIG. 6 is a circuit diagram of the LED module and the driver of FIG. 1.

### DETAILED DESCRIPTION

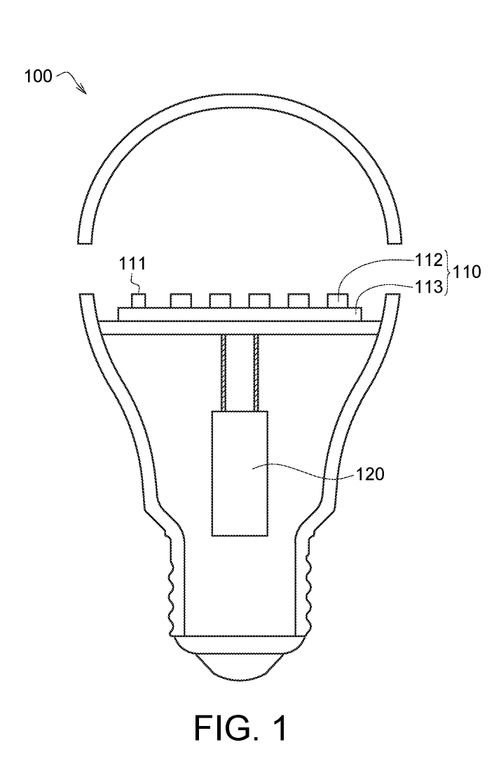

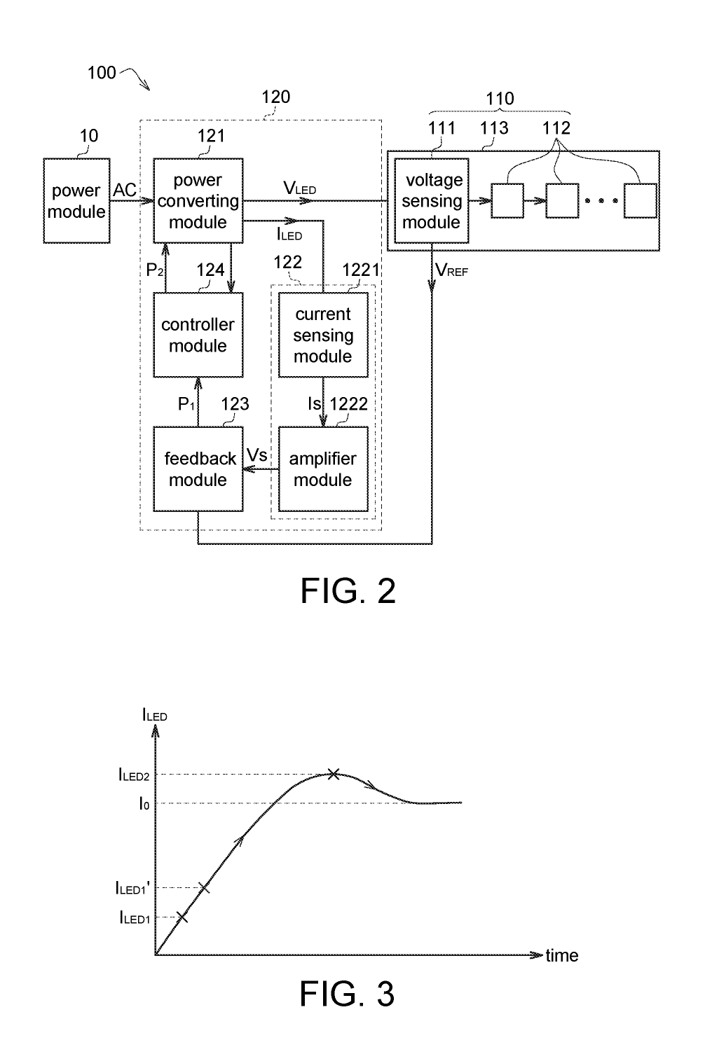

Refer to FIGS. 1 and 2. FIG. 1 is a cross-sectional view of an LED device 100 according to an embodiment of the invention. FIG. 2 is functional diagram of the LED device 100 of FIG. 1.

As indicated in FIG. 1, the light-emitting diode (LED) device 100 can be realized by a bulb or an LED tube containing LED bars. The LED device 100 includes an LED module 110 and a driver 120. The LED module 110 and the driver 120 are two separate elements. That is, the LED module 110 and the driver 120 are not integrated into one element but are manufactured separately. Under such design, the driver 120 can be realized by a switch mode driver.

As indicated in FIG. 2, the LED module 110 includes a voltage sensing module 111, a plurality of LEDs 112 and a circuit board 113. The voltage sensing module 111 and the LEDs 112 are disposed on the circuit board 113 as indicated in FIG. 1. The driver 120 can be electrically connected to the circuit board 113 for controlling the voltage sensing module 111 and the LEDs 112 which are disposed on the circuit board 113.

The voltage sensing module 111 is configured to generate a reference voltage V_{REF}. The reference voltage V_{REF} is determined according to the magnitude of the current required by the LED module 110. For example, the more the magnitude of the current required by the LED module 110 is, the higher the reference voltage V_{REF} can be set to. For example, the magnitude of current is larger when the quantity of the LEDs 112 is more. Conversely, the smaller the magnitude of the current required by the LED module 110 is, the lower the reference voltage V_{REF} can be set to. The driver 120 can provide the driving current I_{LED} required by the LED module 110 according to the magnitude of the reference voltage V_{REF}. Thus, the same driver 120 can provide different currents required by the LED module 110 and there is no need to design different drivers 120 to provide different currents required by the LED module 110, not only reducing the design cost and the manufacturing cost of the LED device 100 but also reducing the workload in warehousing management, material assignment and component assembly.

The driver 120 includes a power converting module 121, a current processing module 122, a feedback module 123 and a controller module 124.

The power converting module 121 is configured to receive an alternating current AC from the power module 10 and further converting the alternating current AC into a direct current driving current I_{LED}. The alternating current AC is provided by such as a mains supply. The driving current I_{LED} is configured to drive the LEDs 112 to emit a light. The driving current I_{LED} could be higher or lower than the current required by the LED module 110.

As indicated in FIG. 3, a curve diagram of driving current I_{LED} according to an embodiment of the invention is shown. For example, when the LED device 100 is turned on, the driving current I_{LED} starts to boost from 0, but the driving current I_{LED1} at the initial stage is insufficient to provide the current I₀ required by the LED module 110. Then, the driving current I_{LED} continues to boost, and may even exceed the current I₀ required by the LED module 110 and reach, for example, a driving current I_{LED2}. If the driving current I_{LED} is too small, the LED module 110 will have insufficient brightness. Conversely, if the driving current I_{LED} is too large, the driving current I_{LED} may damage the LED module 110. By using following methods, the driving current I_{LED} can be boosted or dropped to be basically equivalent to the current I₀ required by the LED module 110, such that the LED module 110 can provide brightness conformed to the specification of design and at the same time the LED module 110 will not be overloaded.

For example, the current processing module 122 converts the driving current I_{LED} outputted from the power converting module 121 into a sensing voltage V_{S}. Then, the feedback module 123 compares the sensing voltage V_{S} with a reference voltage V_{REF} and outputs a level signal P₁ according to a magnitude relationship of the sensing voltage V_{S} and the reference voltage V_{REF}. Then, the controller module 124 outputs a PWM signal P₂ to the power converting module 121 according to the level signal P₁. Then, the power converting module 121 controls the magnitude of the driving current I_{LED} according to PWM signal P₂. The above procedures can be repeated until the driving current I_{LED} is basically equivalent to the current I₀. Detailed descriptions are disclosed below.

The current processing module 122 includes a current sensing module 1221 and an amplifier module 1222. The current sensing module 1221 converts the driving current I_{LED} into a current signal I_{S}, and the amplifier module 1222 further amplifies the current signal and converts the current signal I_{S} into a sensing voltage V_{S}.

The feedback module 123 compares the sensing voltage V_{S} with a reference voltage V_{REF} and outputs a level signal P₁ according to a magnitude relationship of the sensing voltage V_{S} and the reference voltage V_{REF}. For example, if the reference voltage V_{REF} is higher than the sensing voltage V_{S}, the level signal P₁ is set as one of a low-level signal and a high-level signal. In an embodiment of the invention, if the reference voltage V_{REF} is higher than the sensing voltage V_{S}, then the level signal P₁ is at a low level; if the reference voltage V_{REF} is lower than the sensing voltage V_{S}, then the level signal P₁ is at a high level.

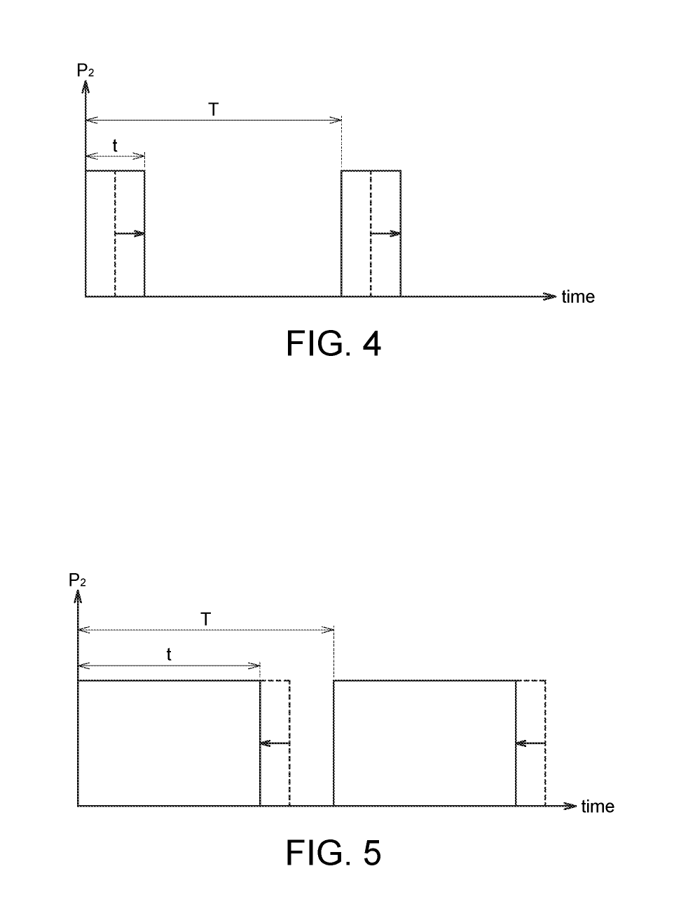

Refer to FIGS. 1 and 4. FIG. 4 is a diagram of PWM signal according to an embodiment of the invention. The controller module 124 outputs a PWM signal P₂ to the power converting module 121 according to the level signal P₁. When the controller module 124 receives a level signal P₁ at a low level (in the present example, this indicates that the reference voltage V_{REF} is higher than the sensing voltage V_{S}), this indicates that the driving current I_{LED} is larger than the current I₀ required by the LED module 110. As indicated in FIG. 3, the driving current I_{LED1} is smaller than the required current I₀. Therefore, in FIG. 4, the controller module 124 increases the duty cycle W1 of PWM signal P₂, for example, from 10% (indicated by dotted lines) to 20% (indicated by solid lines). However, in other embodiments of the invention, the duty cycle W1 is not limited to the said exemplification. For example, the duty cycle W1 can be defined as t/T, that is, a ratio of the turn-on time t to the period T.

Then, the power converting module 121 controls the magnitude of the driving current I_{LED} according to the PWM signal P₂. For example, when the duty cycle W1 of FIG. 4 is increased, the power converting module 121 increases the driving current I_{LED} provided to the LED module 110, and the driving current I_{LED} is boosted to I_{LED1} from I_{LED1} as indicated in FIG. 3.

Then, based on the above principles, the driver 120 continues to judge the magnitude of the sensing voltage V_{S} and the reference voltage V_{REF}, converts the sensing voltage V_{S} into a corresponding driving current I_{LED} and further provides the corresponding driving current I_{LED} to the LED module 110, such that the driving current I_{LED} gets closer and closer to the driving current I₀.

Refer to FIGS. 1 and 5. FIG. 5 is a diagram of PWM signal according to another embodiment of the invention is shown. When the controller module 124 receives a level signal P₁ at a high-level (in the present example, this indicates that the reference voltage V_{REF} is lower than the sensing voltage V_{S}), this indicates that the driving current I_{LED} is larger than the current I₀ required by the LED module 110. As indicated in FIG. 3, the driving current I_{LED2} is larger than the required current I₀. Therefore, in FIG. 5, the controller module 124 decreases the duty cycle W1 of the PWM signal P₂, from example, from 70% (indicated by dotted lines) to 60% (indicated by solid lines). However, in other embodiments of the invention, the duty cycle W1 is not limited to the said exemplification.

Then, the power converting module 121 controls the magnitude of the driving current I_{LED} according to the PWM signal P₂. For example, since the duty cycle W1 of FIG. 5 is decreased, the power converting module 121 decreases the driving current I_{LED} provided to the LED module 110, and the driving current I_{LED} drops to the required current I₀ from the driving current I_{LED2} as indicated in FIG. 3.

Then, based on the above principles, the driver 120 continues to judge the magnitude of the sensing voltage V_{S} and the reference voltage V_{REF}, converts the sensing voltage V_{S} into a corresponding driving current I_{LED} and further provides the corresponding driving current I_{LED} to the LED module 110, such that the driving current I_{LED} is within the permissible range of the current I₀ required by the LED module 110.

It can be known from the above disclosure that the duty cycle W1 of the PWM signal P₂ is proportional to the sensing voltage V_{S}, and the driving current I_{LED} is proportional to duty cycle W1.

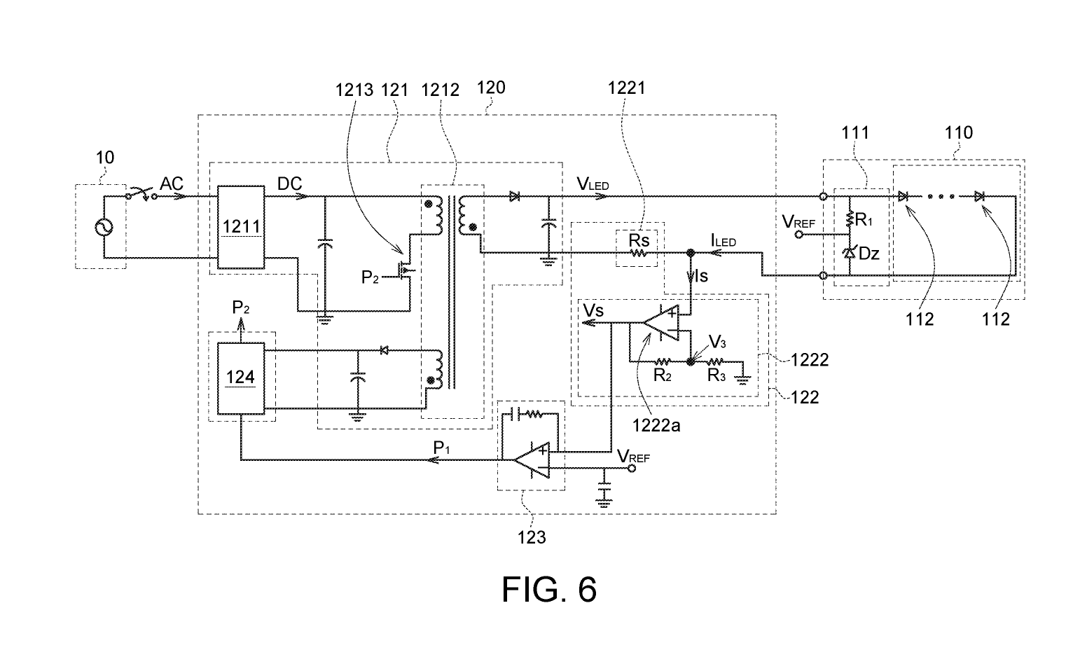

FIG. 6 is a circuit diagram of the LED module 110 and the driver 120 of FIG. 1. The voltage sensing module 111 includes a diode D_{Z}, such as a Zener diode. The reference voltage V_{REF} is determined according to the reverse voltage of the diode D_{Z}. For example, when the diode D_{Z} has a reverse voltage of 17 volts (V), the reference voltage V_{REF} is also about 17 V. Thus, the reference voltage V_{REF} with different design values can be obtained by selecting the diode D_{Z} with different reverse voltages.

The power converting module 121 includes a rectifier 1211, a transformer 1212 and a switch 1213. The rectifier 1211 converts an alternating current AC into a direct current DC. The transformer 1212 changes, for example, drops or boosts the voltage of the direct current DC to a driving voltage V_{LED}. The switch 1213 controls the transformer 1212 to be turned on/off according to the PWM signal P₂. For example, when the PWM signal P₂ is in an ON state, the switch 1213 controls the transformer 1212 to be turned on; when the PWM signal P₂ is in an OFF state, the switch 1213 controls the transformer 1212 to be turned off.

The current sensing module 1221 can be realized by such as a resistor R_{S}. The current signal I_{S} is a diverted current of the driving current I_{LED}, and the value of the current signal I_{S} is determined according to the value of the resistor R_{S}. That is, a corresponding current signal I_{S} can be obtained through the design of the resistor R_{S}.

The amplifier module 1222 can be composed of an amplifier 1222a and two series-connected resistors R₂ and R₃. When the current signal I_{S} flows through the resistor R₃, a corresponding voltage difference V₃ will be generated.

The feedback module 123 can be realized by such as a comparer, which compares the magnitude of the sensing voltage V_{S} with that of the reference voltage V_{REF} and accordingly outputs a level signal P₁.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A light-emitting diode (LED) device, comprising:
an LED module, comprising:
a voltage sensing module configured to generate a reference voltage; and
an LED;
a driver, comprising:
a power converting module configured to receive and convert an alternating current (AC) into a driving current for driving the LED to emit light;
a current processing module configured to convert the driving current into a sensing voltage;
a feedback module configured to compare the sensing voltage with a reference voltage and output a level signal according to a magnitude relationship of the sensing voltage and the reference voltage; and
a controller module configured to output a pulse width modulation (PWM) signal to the power converting module according to the level signal;
wherein, the power converting module is further configured to control a magnitude of the driving current according to the PWM signal.

2. The LED device according to claim 1, wherein a duty cycle of the PWM signal is proportional to the sensing voltage.

3. The LED device according to claim 1, wherein the driving current is proportional to a duty cycle of the PWM signal.

4. The LED device according to claim 1, wherein the controller module is further configured to:
increase a duty cycle of the PWM signal if the reference voltage is higher than the sensing voltage.

5. The LED device according to claim 1, wherein the controller module is further configured to:
decrease a duty cycle of the PWM signal if the reference voltage is lower than the sensing voltage.

6. The LED device according to claim 1, wherein the feedback module is further configured to:
set a level signal as one of a low-level signal and a high-level signal if the reference voltage is higher than the sensing voltage; and
set the level signal as the other one of the low-level signal and the high-level signal if the reference voltage is lower than the sensing voltage.

7. The LED device according to claim 1, wherein the current processing module comprises:
a current sensing module configured to convert the driving current into a current signal; and
an amplifier module configured to amplify the current signal and convert the current signal into the sensing voltage.

8. The LED device according to claim 1, wherein the driver is a switch mode driver.

9. The LED device according to claim 1, wherein the voltage sensing module comprises a diode, and the reference voltage is determined according to a reverse voltage of the diode.

10. The LED device according to claim 9, wherein the diode is a Zener diode.

11. The LED device according to claim 1, wherein the driver and the LED module are disposed separately.

12. The LED device according to claim 1, wherein the LED module comprises a circuit board on which the voltage sensing module and the LED are disposed.

13. The LED device according to claim 1, wherein the current sensing module is a resistor.
